(19) United States
(12) Patent Application Publication
(10) Pub. No.: US 2025/0380164 A1
(43) Pub. Date: Dec. 11, 2025

(54) REDUNDANT SATELLITE BACKHAUL USING A SECONDARY CELLULAR NETWORK CORE

(71) Applicant: DISH Wireless L.L.C., Littleton, CO (US)

(72) Inventors: Siddhartha Chenumolu, Ashburn, VA (US); Mehdi Alasti, Arlington, VA (US)

(21) Appl. No.: 18/735,847

(22) Filed: Jun. 6, 2024

(51) Int. Cl. H04W 24/04; H04W 24/02; H04W 84/06

(52) U.S. Cl. CPC H04W 24/04; H04W 24/02; H04W 84/06

(57) ABSTRACT

Various arrangements for providing redundant backhaul for a cellular network are provided herein. A secondary cellular network core can be in communication with a primary cellular network core. The secondary cellular network core can be configured such that components of the secondary cellular network core are optimized for satellite communications, while the components of the primary cellular network core are optimized for wired communications. In response to a determination that the primary backhaul connection is not available for accessing the primary cellular network core, cellular network services can instead be provided via the satellite backhaul connection and the secondary cellular network core.

### BACKGROUND

The uptime of cellular network systems can be of utmost importance for end users and for entities that operate devices that rely on such networks for communication. Even if a cellular network system is, for example, 99.95% reliable, approximately five hours of downtime can be expected every year, which may be scattered throughout the year resulting in a meaningful amount of downtime in some months.

One of the causes of cellular network downtime can be problems with backhaul communication from components of the network at the edge with the cellular network core. Arrangements detailed herein focus on improving cellular network uptime by overcoming backhaul communication interruptions.

### SUMMARY

Various embodiments are described related to a system for providing redundant backhaul for a cellular network. In some embodiments, a system for providing redundant backhaul for a cellular network is described. The system may comprise a cellular network access point. User equipment may communicate with the cellular network access point wirelessly using a cellular radio access technology. The system may comprise a primary cellular network core. The cellular network access point may use the primary cellular network core for providing core cellular network functionality. The system may comprise a primary backhaul connection for communication between the cellular network access point and the primary cellular network core. The system may comprise a secondary cellular network core comprising at least one component redundant to and configured differently than a counterpart component of the primary cellular network core. The secondary cellular network core may be in communication with the primary cellular network core. The system may comprise a satellite backhaul connection that may provide a communication path between the cellular network access point and the secondary cellular network core. The satellite backhaul connection may be used for cellular network communications with the UE performed via the cellular network access point in response to the primary backhaul connection being unavailable.

Embodiments of such a system may include one or more of the following features: the at least one component redundant to and configured differently than a counterpart component of the primary cellular network core may be configured differently to account for greater latency of the satellite backhaul connection compared with the primary backhaul connection. The at least one component may comprise an access and mobility management function (AMF). One or more timers of the AMF of the secondary cellular network core may be configured based on latency of the satellite backhaul connection. The at least one component may comprise a user plane function (UPF). The UPF may be configured to deliver a quality of service (QOS) based on bandwidth availability of the satellite backhaul connection. The core cellular network functionality may comprise authentication of user equipment authorized to communicate using the cellular network. The system may further comprise an edge switch, connected with the cellular network access point, that routes data from the cellular network access point to the satellite backhaul connection when the primary backhaul connection is determined to be unavailable. The secondary cellular network core may comprise only a subset of components that are redundant to a set of components of the primary cellular network core. The primary cellular network core and the secondary cellular network core may be implemented on a public cloud computing platform. When the satellite backhaul connection is used for cellular network communications in response to the primary backhaul connection being unavailable, an amount of processing resources reserved on the public cloud computing platform for the at least one component may be increased. The system may further comprise a second cellular network access point. The second cellular network access point accesses the satellite backhaul connection via an integrated access and backhaul (IAB) connection with the cellular network access point.

In some embodiments, a system for providing redundant backhaul for a cellular network is described. The system may comprise a primary cellular network core. One or more cellular network access points may use the primary cellular network core for providing core cellular network functionality. A secondary cellular network core may comprise at least one component redundant to and configured differently than a counterpart component of the primary cellular network core. The secondary cellular network core may be in communication with the primary cellular network core. A satellite backhaul connection that may provide a communication path between a cellular network access point and the secondary cellular network core. The satellite backhaul connection may be used for cellular network communications with the cellular network access point in response to a primary backhaul connection being unavailable.

Embodiments of such a system may include one or more of the following features: the at least one component redundant to and configured differently than a counterpart component of the primary cellular network core may be configured differently to account for greater latency of the satellite backhaul connection compared with the primary backhaul connection. The at least one component may comprise an access and mobility management function (AMF). One or more timers of the AMF of the secondary cellular network core may be configured based on latency of the satellite backhaul connection. The at least one component may comprise a user plane function (UPF). The UPF may be configured to deliver a quality of service (QOS) based on bandwidth availability of the satellite backhaul connection, a latency of the satellite backhaul connection, or both. The primary cellular network core and the secondary cellular network core may be implemented on a public cloud computing platform. When the satellite backhaul connection is used for cellular network communications in response to the primary backhaul connection being unavailable, an amount of processing resources reserved on the public cloud computing platform for the at least one component may be increased.

In some embodiments, a method for providing redundant backhaul for a cellular network is described. The method may comprise creating a secondary cellular network core in communication with a primary cellular network core. The method may comprise configuring the secondary cellular network core such that at least one component of the secondary cellular network core may be configured differently than a counterpart component of the primary cellular network core. The method may comprise providing cellular network services to a plurality of user equipment using a primary backhaul connection and the primary cellular network core. The method may comprise determining that the primary backhaul connection is not available for accessing the primary cellular network core. The method may comprise in response to determining that the primary backhaul connection is not available for accessing the primary cellular network core, providing cellular network services using a satellite backhaul connection and the secondary cellular network core. The at least one component configured differently than a counterpart component of the primary cellular network core may be configured differently to account for greater latency of the satellite backhaul connection compared with the primary backhaul connection. The primary cellular network core and the secondary cellular network core may be implemented on a public cloud computing platform. The method may further comprise increasing an amount of processing resources reserved on the public cloud computing platform for the at least one component when the satellite backhaul connection is used for cellular network communications.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an embodiment of a system that provides redundant satellite-based backhaul using a secondary cellular network core.

FIG. 2 illustrates an embodiment of a cellular network core.

FIG. 3 illustrates an embodiment of a cellular network core implemented on a cloud computing system.

FIG. 4 illustrates another embodiment of a system that provides redundant satellite-based backhaul using a secondary cellular network core.

FIG. 5 illustrates an embodiment of a method for providing redundant satellite-based backhaul using a secondary cellular network core.

### DETAILED DESCRIPTION

A secondary network connection, such as a satellite backhaul connection, can be used to augment a primary backhaul connection, which may be a wired connection. Such augmentation can allow for a failover operation to occur in which communication between cellular network access points and a cellular network core are performed through the satellite backhaul connection instead of the primary backhaul connection. Therefore, if the primary backhaul connection becomes unavailable, the secondary network connection can be used to maintain communication between cellular network access points (APs) and the cellular network core.

Depending on the characteristics of a network connection, various cellular network core components may need to be configured differently to function effectively. For example, if the primary backhaul connection uses a wired (e.g., fiber optic) connection, the latency between the primary cellular network core and cellular network APs may be relatively short. However, if the secondary network connection is used instead, which can be a satellite-based network connection, latency may be significantly greater and available bandwidth may be decreased. Based on such changes in the properties of the network connections, various parameters of cellular network core components can be adjusted to improve performance.

Notably, however, while the primary backhaul connection may not be available for a first group of one or more cellular network APs, a cellular network core may remain accessible for other cellular network APs; therefore, adjusting parameters of components of the cellular network core may not be advisable, as these changes could negatively affect performance involving cellular networks AP that remain in communication with the cellular network core. Instead, as detailed herein, a secondary cellular network core can be maintained in which cellular network functions (NFs) are configured for effective satellite backhaul communications as opposed to wired communications. Such an arrangement allows the secondary cellular network core to only be used when needed and can be idle otherwise; that is, when a primary backhaul connection is unavailable, a failover operation to the satellite network backhaul connection occurs, which causes the secondary cellular network core to be utilized.

Cellular network components can be virtualized and implemented on general-purpose computing hardware. In some embodiments, a cellular network core can be implemented on a cloud computing platform, such as a public computing platform. Such an arrangement can allow for a significant amount of computing resources to be available on demand when needed. As such, the secondary network core can be created and maintained for when needed. When the failover operation occurs, a larger amount of computing resources can be reserved for the cellular network on the cloud computing platform for the secondary cellular network core, thus providing the secondary cellular network core with sufficient resources to provide core functionality for the cellular network APs using the satellite backhaul connection.

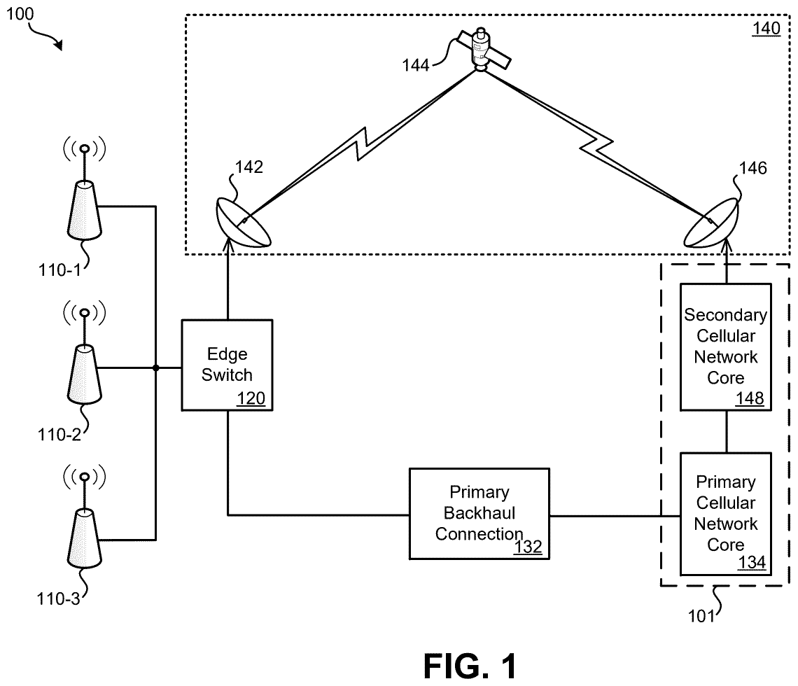

Further detail is provided in relation to the figures. FIG. 1 illustrates an embodiment of a system 100 that provides redundant satellite-based backhaul using a secondary cellular network core. System 100 can include: cellular network APs 110 (e.g., 110-1, 110-2, 110-3), edge switch 120; secondary backhaul system 140.

Cellular network APs 110 are used to provide cellular network service to multiple user equipment (UE). UE communicate wirelessly with at least one of cellular network APs 110 using a cellular radio access technology (RAT), such as 5G New Radio (NR). In some embodiments, one or more of cellular network APs 110 can be a base station (e.g., gNodeB). Additionally or alternatively, one or more of cellular network APs 110 can be installed to service a more localized area, such as the inside of a warehouse or factory. Such one or more of cellular network APs 110 may only allow for UE mapped to a particular cellular network slice or a client to use one or more of cellular network APs 110 for network access. As an example, an entity may operate hundreds or thousands of pieces of equipment that rely on cellular communications. These pieces of equipment can use a cellular RAT for communication with one or more of cellular network APs 110.

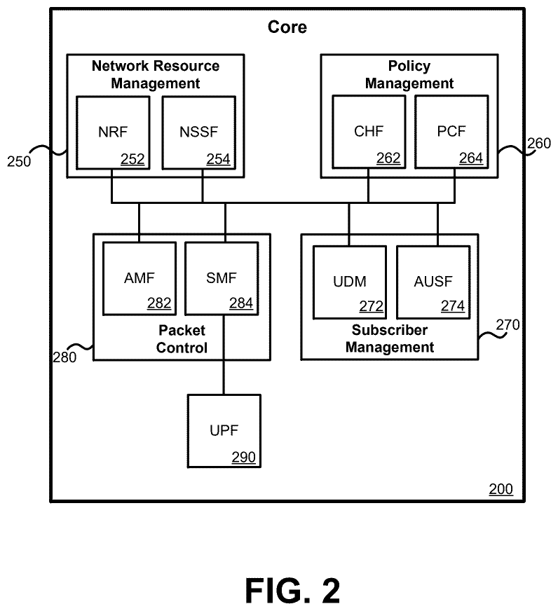

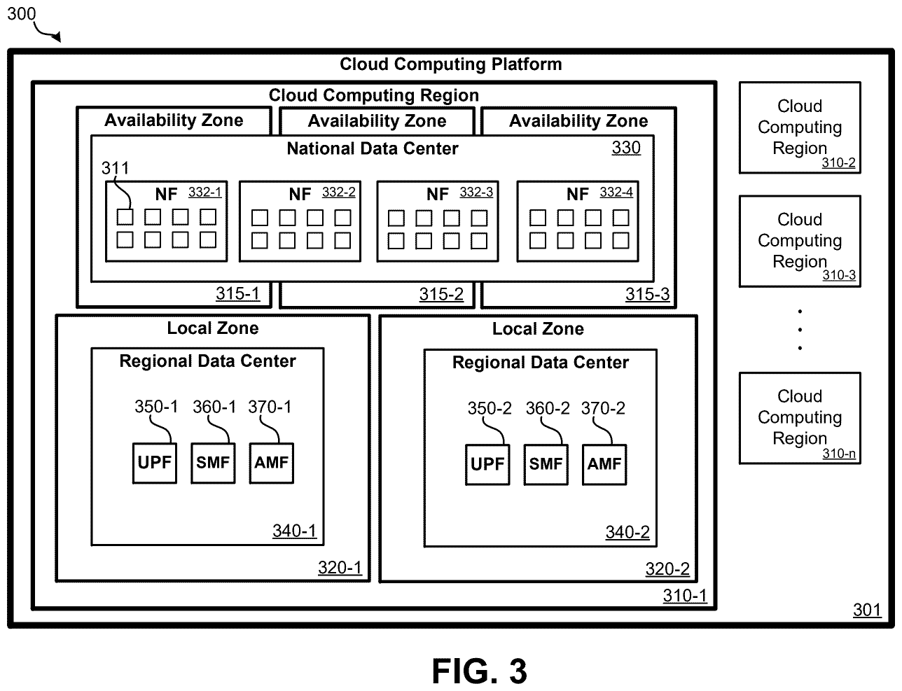

In a 5G NR cellular network, a gNodeB includes various components including at least one radio unit (RU), at least one distributed unit (DU), and at least one centralized unit (CU). At least some of such components may be integrated with or local to cellular network APs 110. The radio unit may be used for performing RF communication with UE and the DU may be responsible for functions such as scheduling wireless communications of the UE. In addition to components of the gNodeB, in order to function, access to the cellular network core is necessary. The cellular network core, as detailed in relation to FIGS. 2 and 3, performs higher-level functions, such as authentication, billing, Internet access, and/or messaging. The cellular network core is remote from components of the gNodeB, such as at a centralized server or cloud server system and provides services for multiple gNodeBs. Other forms of cellular networks, such as 4G, 6G, and beyond can have a similar structure in which a centralized core is needed to provide at least some cellular network services.

During normal operation, when primary backhaul connection 132 is available, all cellular communication traffic between cellular network APs 110 and primary cellular network core 134 can be transmitted using primary backhaul connection 132. Primary backhaul connection 132 may be a wired communication arrangement, such as fiber optic, coaxial cable, or other form of wired communication that allows for the transmission of data. Primary backhaul connection 132 can involve edge switch 120 being connected with an Internet Service Provider (ISP) that provides a high-speed connection with the Internet through which primary cellular network core 134 can be accessed or through a private network through which primary cellular network core 134 can be accessed.

While highly reliable, primary backhaul connection 132 can be expected to be unavailable for some amount of time on an annual basis. Typical problems can involve a cut fiber or other form of wire, equipment failure, power outage, etc. When primary backhaul connection 132 is unavailable, in order to provide cellular network access and functionality to UE communicating with cellular network APs 110, an alternative backhaul communication path to the cellular network core is needed. Notably, just because primary backhaul connection 132 is unavailable to cellular network APs 110, other cellular network APs that use a different primary backhaul connection may still be communicating with primary cellular network core 134. As such, primary cellular network core 134 continues to service APs, gNodeBs, and/or UE, just not systems and devices involving cellular network APs 110.

When cellular network APs 110 or edge switch 120 itself detects that primary cellular network core 134 is no longer accessible via primary backhaul connection 132, all or at least some communication traffic is routed by edge switch 120 to the cellular network core. Secondary backhaul system 140 provides an alternative backhaul route to the cellular network core than primary backhaul connection 132; therefore problems with primary backhaul connection 132 can be avoided.

In some embodiments, secondary backhaul system 140 uses a non-terrestrial network (NTN) comprising one or more satellites. At a high level, in an NTN, data is transmitted to a satellite by a first gateway, which in turn transmits the data to a second gateway in another geographic location. Data from the second gateway is then routed to the cellular network core. Secondary backhaul system 140 can include: gateway 142, satellite 144, and gateway 146. Gateways 142 and 136 can receive data from and transmit data to satellite 144. Satellite 144 may be in geosynchronous orbit (GEO), middle earth orbit (MEO), or in low earth orbit (LEO). If in LEO or MEO, many satellites may be used in order to provide communication via secondary backhaul system 140. Gateway 146 can be in communication, such as via a public or private network, with secondary cellular network core 148.

In other embodiments, secondary backhaul system 140 may take another form other than an NTN. For example, while primary backhaul connection 132 may be via a first ISP, secondary backhaul system 140 may be via a different ISP that utilizes a different wired network or a point-to-point microwave wireless communication link. As such, an interruption in primary backhaul connection 132 would not be expected to affect secondary backhaul system 140.

Collectively, primary cellular network core 134 and secondary cellular network core 148 can be referred to as the cellular network core system. Secondary cellular network core 148 is specifically configured or optimized for communication via secondary backhaul system 140, which in this case is an NTN. An NTN can have significantly different operating characteristics than a wired network. Notably, latency can be significantly higher, especially if satellite 144 is a geosynchronous satellite due to the amount of time RF takes to propagate to and from satellite 144.

Secondary cellular network core 148 includes NFs that are also present in primary cellular network core 134. All or at least some of the NFs present in secondary cellular network core 148 are at least partially configured differently than the counterpart NFs in primary cellular network core 134. Specifically, the NFs of secondary cellular network core 148 are optimized for communication via secondary backhaul system 140, such as to account for increased latency and/or lower available bandwidth.

The NFs of secondary cellular network core 148 are in communication with other NFs of primary cellular network core 134. For example, an AMF of secondary cellular network core 148 can access primary cellular network core 134 to communicate with other NFs and can access a common data storage arrangement (e.g., memory) such that the AMF or secondary cellular network core 148 reads and writes to the same data storage arrangement as the AMF of primary cellular network core 134. As such, in this example, the AMF of secondary cellular network core 148 can seamlessly interact with state information and stored data created by the counterpart AMF of primary cellular network core 134. Similarly, when primary backhaul connection 132 is restored, the counterpart AMF of primary cellular network core 134 can seamlessly resume managing state information and stored data created by the AMF of secondary cellular network core 148.

After primary backhaul connection 132 is reestablished such that cellular network APs 110 can communicate, at a sufficient bandwidth, with primary cellular network core 134, edge switch 120 can resume routing communication via primary backhaul connection 132 directly to primary cellular network core 134. For such communications, secondary cellular network core 148 may remain unused and can be idle, ready for the next time primary backhaul connection 132 is unavailable.

Cellular network core system 101, including both secondary cellular network core 148 and primary cellular network core 134, can be implemented on a cloud computer system, such as a public cloud computing system. As an example, Amazon Web Services (AWS) can be used to implement cellular network core system 101. Further detail regarding how a public cloud computing system can be used to implement cellular network core system 101 is provided in relation to FIG. 3.

Notably, the amount of processing resources reserved for secondary cellular network core 148 can be varied based on the load experienced by secondary cellular network core 148. During normal operation, when primary backhaul connection 132 is fully functional, secondary cellular network core 148 can be idle. As such, a small amount of processing resources need to be allocated to keep the NFs of secondary cellular network core 148 idle and on standby for when needed. In response to secondary cellular network core 148 being routed cellular network communications through secondary backhaul system 140, additional processing resources can be allocated by the public cloud computing system to secondary cellular network core 148 such that secondary cellular network core 148 can handle the necessary processing. Accordingly, processing resources are only allocated to secondary cellular network core 148 when dictated by load.

While in some embodiments edge switch 120 routes data via secondary backhaul system 140 in response to primary backhaul connection 132 failing, in other embodiments, load balancing may be performed if, for example, primary backhaul connection 132 has insufficient bandwidth. In such an instance, some or all of the cellular communication traffic associated with cellular network APs can be routed via secondary backhaul system 140.

FIG. 2 illustrates an embodiment of a cellular network core 200, which can function as primary cellular network core 134 of FIG. 1. Each of the functions of core 200 may not be present at the edge of the cellular network; thus components of cellular network APs 110 (e.g., DUs, CUs) communicate with core 200 in order to access the functionality provided by the network functions of core 200. Cellular network core 200 can be physically distributed across data centers or located at a central national data center (NDC), such as detailed in relation to FIG. 3, and can perform various core functions of the cellular network. Core 200 can include: network resource management components 250; policy management components 260; subscriber management components 270; and packet control components 280. Individual components may communicate via a bus or network, thus allowing various components of core 200 to communicate with each other directly. Core 200 is simplified to show some key components. Implementations can involve additional components.

Network resource management components 250 can include: Network Repository Function (NRF) 252 and Network Slice Selection Function (NSSF) 254. NRF 252 can allow 5G network functions (NFs) to register and discover each other via a standards-based application programming interface (API). NSSF 254 can be used by AMF 282 to assist with the selection of a network slice that will serve a particular UE.

Policy management components 260 can include: Charging Function (CHF) 262 and Policy Control Function (PCF) 264. CHF 262 allows charging services to be offered to authorized network functions. Converged online and offline charging can be supported. PCF 264 allows for policy control functions and the related 5G signaling interfaces to be supported.

Subscriber management components 270 can include: Unified Data Management (UDM) 272 and Authentication Server Function (AUSF) 274. UDM 272 can allow for generation of authentication vectors, user identification handling, NF registration management, and retrieval of UE individual subscription data for slice selection. AUSF 274 performs authentication with UEs.

Packet control components 280 can include: Access and Mobility Management Function (AMF) 282 and Session Management Function (SMF) 284. AMF 282 can receive connection-and session-related information from UEs and is responsible for handling connection and mobility management tasks. SMF 284 is responsible for interacting with the decoupled data plane, creating updating and removing Protocol Data Unit (PDU) sessions, and managing session context with the User Plane Function (UPF).

User plane function (UPF) 290 can be responsible for packet routing and forwarding, packet inspection, quality of service (QOS) handling, and external PDU sessions for interconnecting with a Data Network (DN) (e.g., the Internet) or various access networks 297.

Core 200 may be executed on a public third-party cloud-based computing platform or a cloud-based computing platform operated by the same entity that operates the RAN, including cellular network APs 110. A cloud-based computing platform may have the ability to devote additional hardware resources to such network functions or implement additional instances of such network functions when requested. A “public” cloud-based computing platform refers to a platform where various unrelated entities can each establish an account and separately utilize the cloud computing resources, the cloud computing platform managing segregation and privacy of each entity's data.

Kubernetes, or some other container orchestration platform, can be used to create and destroy the logical NFs as needed, for core 200 to function properly. Kubernetes allows for container deployment, scaling, and management. As an example, if cellular traffic increases substantially in a region, an additional logical DU or components of a DU may be deployed in a data center near where the traffic is occurring without any new hardware being deployed; rather, processing and storage capabilities of the data center would be devoted to the needed functions.

The deployment, scaling, and management of such virtualized components can be managed by an orchestrator component. An orchestrator can represent various software processes executed by underlying computer hardware. An orchestrator can monitor a cellular network and determine the amount and location at which cellular network functions should be deployed to meet or attempt to meet service level agreements (SLAs) across slices of the cellular network.

Secondary cellular network core 148 may include only a subset of network functions present in primary cellular network core 134. In secondary cellular network core 148, only NFS may be present that require different configuration parameters to function effectively via secondary backhaul system 140. The components of secondary cellular network core 148 can be in communication with primary cellular network core 134 such that NFs present in secondary cellular network core 148 can access and communicate with other NFs in primary cellular network core 134. Further, secondary cellular network core 148 and primary cellular network core 134 can share a common data repository, thus allowing states and data related to ongoing calls and communications to be handled by either the NFs of secondary cellular network core 148 or primary cellular network core 134.

FIG. 3 illustrates an embodiment of a cellular network core topology 300 as implemented on a public cloud-computing platform, according to certain embodiments. The cellular network core topology 300 can be an implementation of the core 200 of FIG. 2. Cellular network core topology 300 can represent how logical cellular network groups are distributed across the cloud computing infrastructure of cloud computing platform 301. Cloud computing platform 301 can be logically and physically divided up into various different cloud computing regions 310. Each of cloud computing regions 310 can be isolated from other cloud computing regions to help provide fault tolerance, fail-over, load-balancing, and/or stability and each of cloud computing regions 310 can be composed of multiple availability zones, each of which can be a separate data center located in general proximity to each other (e.g., within 600 miles). Further, each of cloud computing regions 310 may provide superior service to a particular geographic region based on physical proximity. For example, cloud computing region 310-1 may have its datacenters and hardware located in the northeast of the United States while cloud computing region 310-2 may have its datacenters and hardware located in California. For simplicity, the details of the cellular network as executed in only cloud computing region 310-1 is illustrated. Similar components may be executed in other cloud computing regions of cloud computing regions 310 (310-2, 310-3, 310-n).

In other embodiments, cloud computing platform 301 may be a private cloud computing platform. A private cloud computing platform may be maintained by a single entity, such as the entity that operates the hybrid cellular network. Such a private cloud computing platform may be only used for the hybrid cellular network and/or for other uses by the entity that operates the hybrid cellular network (e.g., streaming content delivery).

Each of cloud computing regions 310 may include multiple availability zones 315. Each of availability zones 315 may be a discrete data center or group of data centers that allows for redundancy that allows for fail-over protection from other availability zones within the same cloud computing region. For example, if a particular data center of an availability zone experiences an outage, another data center of the availability zone or separate availability zone within the same cloud computing region can continue functioning and providing service. A logical cellular network component, such as a national data center, can be created in one or across multiple availability zones 315. For example, a database that is maintained as part of NDC 330 may be replicated across availability zones 315; therefore, if an availability zone of the cloud computing region is unavailable, a copy of the database remains up-to-date and available, thus allowing for continuous or near continuous functionality.

On a (e.g., public) cloud computing platform, cloud computing region 310-1 may include the ability to use a different type of data center or group of data centers, which can be referred to as local zones 320. For instance, a client, such as a provider of the hybrid cloud cellular network, can select from more options of the computing resources that can be reserved at an availability zone 315 compared to a local zone 320. However, a local zone 320 may provide computing resources nearby geographic locations where an availability zone 315 is not available. Therefore, to provide low latency, certain network components, such as regional data centers 340, can be implemented at local zones 320 rather than availability zones 315. In some circumstances, a geographic region can have both a local zone 320 and an availability zone 315.

In the topology of a 5G NR cellular network, 5G core functions of core 200 can logically reside as part of a national data center (NDC) 330. NDC 330 can be understood as having its functionality existing in cloud computing region 310-1 across multiple availability zones 315. At NDC 330, various network functions, such as NFs 332, are executed. For illustrative purposes, each NF 332, whether at NDC 330 or elsewhere located, can be comprised of multiple sub-components, referred to as pods (e.g., pod 311) that are each executed as a separate process by the cloud computing region 310. The illustrated number of pods 311 is merely an example; fewer or greater numbers of pods 311 may be part of the respective 5G core functions. It should be understood that in a real-world implementation, a cellular network core, whether for 5G or some other standard, can include many more network functions. By distributing NFs 332 across availability zones 315, load-balancing, redundancy, and fail-over can be achieved. In local zones 320, multiple regional data centers 340 can be logically present. Each of regional data centers (RDCs) 340 may execute 5G core functions for a different geographic region or group of RAN components. As an example, 5G core components that can be executed within an RDC, such as RDC 340-1, may be: UPFs 350, SMFs 360, and AMFs 370. While instances of UPFs 350 and SMFs 360 may be executed in local zones 320, SMFs 360 may be executed across multiple local zones 320 for redundancy, processing load-balancing, and fail-over.

Secondary cellular network core 148 can be implemented using the same cloud computing platform, cloud computing region, and availability zones 315 as primary cellular network core 134. Similarly, components of secondary cellular network core 148 that are implemented via regional data centers can be implemented using RDCs 340 as primary cellular network core 134.

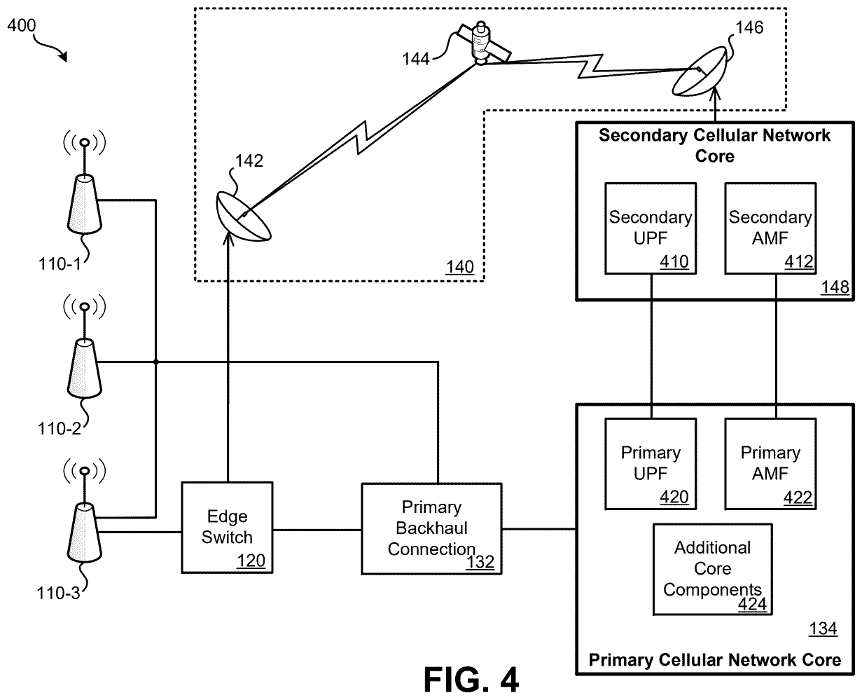

FIG. 4 illustrates another embodiment of a system 400 that provides redundant satellite-based backhaul using a secondary cellular network core. System 400 represents an embodiment of system 100 in which more detail is provided regarding the specific NFs present in secondary cellular network core 148. Within secondary cellular network core 148, secondary UPF 410 and secondary AMF 412 are shown as present. These NFs have counterparts within primary cellular network core 134: primary UPF 420 and primary AMF 422. Secondary UPF 410 and secondary AMF 412 may only be used instead of primary UPF 420 and primary AMF 220, respectively, when secondary backhaul system 140 is being used by APs 110 because primary backhaul connection 132 is unavailable. Secondary cellular network core 148 may rely on primary cellular network core 134 for other NFs, which may not need parameters configured differently in order to function efficiently via secondary backhaul system 140.

As an example of how NFs may be configured with different parameters based on characteristics of the backhaul communication link, secondary UPF 410 and secondary AMF 412 are shown. Secondary UPF 410 may have level-four parameters in the open systems interconnection (OSI) model set different than primary UPF 420. As an example, transmission control protocol/Internet Protocol (TCP/IP) may be used as the transport level communication protocol. Significant latency may be present due to the communications between the secondary cellular network core 148 and cellular network APs 110 occurring via satellite. The significant round-trip latency for TCP/IP between user equipment communicating with cellular network APs 110 and secondary UPF 410 can result in a false detection of network congestion. In response to this false detection, the TCP/IP window manager can decrease the TCP window size, resulting in lower data throughput. Other embodiments involve other forms of level four optimization, such as secondary cellular network core 148 terminating the TCP sockets and initiating a Quick UDP Internet Connection (QUIC) session that does not use the same window management as TCP.

In order to better optimize for satellite communications, a TCP/IP session between UE and secondary UPF 410 can be created with an additional TCP/IP session between the secondary UPF 410 and the destination of the communications with the UE (e.g., a website, Internet-accessible service). This arrangement involving two UPF sessions is not present when primary UPF 420 is used. Rather, in such an arrangement, the TCP/IP session can be directly from the UE to the destination of the communications.

As another example, one or more timers of secondary AMF 412 can be set with longer time values than times of primary AMF 212. These adjustments can be made to compensate for the additional latency present in secondary backhaul system 140. As an example, timers that may be increased in duration for the secondary AMF 412 compared to primary AMF 422 can be: T3502, T3512, T3522, T3550, T3555, T3560, and T3570. These timers may typically have a default value of 5-6 seconds. This value may be increased for secondary AMF 412 to account for the additional latency. For example, the values may be increased to 7-8 seconds.

Secondary UPF 410 and primary UPF 420 are shown as in communication. Similarly, secondary AMF 412 and primary AMF 422 are shown as in communication. As previously detailed, these NFs can share common data repositories such that state data and data related to ongoing communication sessions may be accessible by either the NF of the secondary cellular network core 148 or the NF of the primary cellular network core 134.

If an NF is not present in secondary cellular network core 148, processing needing to be performed by such an NF may be passed to the appropriate NF of additional core components 424 of primary cellular network core 134. Therefore, only NFs that are configured differently than the NFs of primary cellular network core 134 may be present in secondary cellular network core 148.

FIG. 4 also illustrates an alternative architecture for communication among access points. (Embodiments of system 400 can also use the architecture of system 100 for communication with edge switch 120.) As previously detailed, cellular network APs 110 may be gNodeBs. A particular AP, such as AP 110-3, may be connected with edge switch 120. One or more additional APs, such as APs 110-1 and 110-2, may be communications with AP 110-30 and rely on AP 110-3 for communication with edge switch 120. Integrated access and backhaul (IAB) can be implemented according to 3GPP Release 16, which allows for AP 110-3 to function as a donor node through which other APs can access secondary backhaul system 140. Therefore, if primary backhaul connection 132 fails to provide connectivity to primary cellular network core 134, APs 110-1 and 110-2 may route communications using IAB to AP 110-3, which may route communications via secondary backhaul system 140 to secondary cellular network core 148.

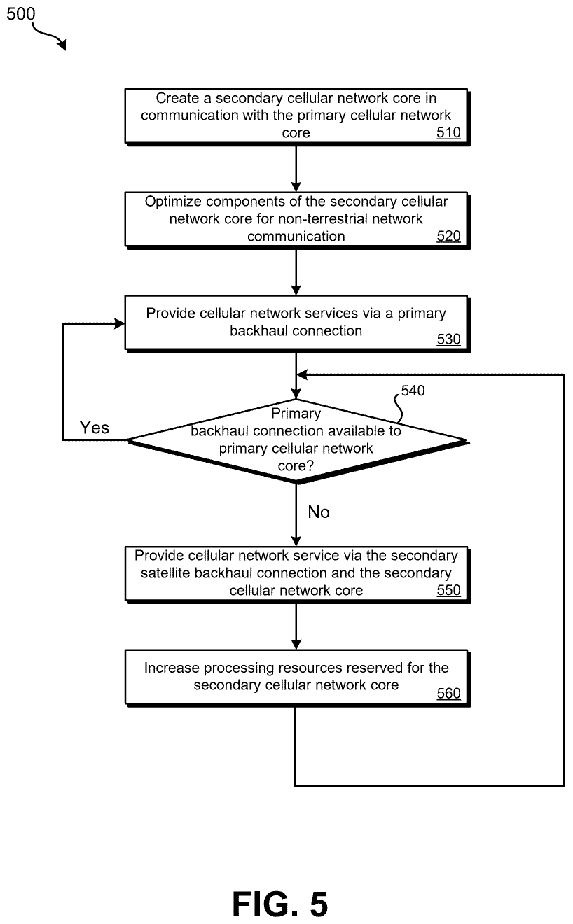

Various methods can be performed using the systems and arrangements detailed in FIGS. 1-4. FIG. 5 illustrates an embodiment of a method 500 for providing redundant satellite-based backhaul using a secondary cellular network core. Method 500 can be performed using system 100, which can include an embodiment of core 200 of FIG. 2. Core 200 can be implemented on a cloud-computing platform as detailed in relation to cellular network core topology 300 of FIG. 3.

At block 510, a secondary cellular network core may be created. The secondary cellular network core can be in communication with a common data storage arrangement of a primary cellular network core. The secondary cellular network core includes one or more network functions that are also present in the primary cellular network core. Not all NFs present in the primary cellular network core may be present in the secondary cellular network core. The secondary cellular network core can be created on the same cloud computing platform as the primary cellular network core, such as detailed in relation to FIG. 3.

At block 520, NFs present in secondary cellular network core may be configured to perform more efficiently or optimally using a secondary backhaul communication link. In some embodiments, this secondary backhaul communication link may utilize a non-terrestrial network, and thus may have increased latency and possibly decreased bandwidth. Examples of parameters of the NFs of secondary cellular network core that may be adjusted are detailed in relation to FIG. 4.

At block 530, cellular network services can be provided by one or more cellular network access points (e.g., gNodeBs, private access points, such as in a factory) to one or more pieces of UE. By default, if the primary cellular network core is accessible via a primary backhaul connection, the primary backhaul connection may be used to the exclusion of any secondary backhaul connection.

At block 540, a determination is made as to whether the primary backhaul connection is available. In some embodiments, when data stops being received for a defined amount of time from the primary cellular network core or the primary cellular network core stops responding to one or more pings, a determination is made that the primary backhaul connection has failed. As long as the primary backhaul connection to the primary cellular network core remains available, block 530 continues to be performed such that cellular network connections between the relevant cellular network APs and the primary cellular network core are routed via the primary backhaul connection.

At block 550, in response to the determination of the primary backhaul connection not being available, cellular network service is instead provided via a secondary backhaul connection, which may involve communication being performed via satellite. Cellular network communications sent via the secondary backhaul connection are processed using the secondary cellular network core created at block 510. As such, the cellular network communications are handled using the NFs that are configured differently than the NFs of the primary cellular network core. Some NFs may only be present in the primary cellular network core and may continue to be processed by such NFs.

At block 560, which can be performed before block 550 in response to block 540 or can be performed in response to block 550, the amount of processing resources reserved on the cloud-computing platform for the secondary cellular network core can be increased. When not being used, the amount of processing resources reserved for the NFs of the secondary cellular network core may be kept relatively minimal. However, when the secondary cellular network core is about to be or is being utilized, the amount of processing resources reserved for instances of NFs of the secondary cellular network core is increased. The amount of processing resources reserved may be decreased once the secondary cellular network core returns to idle when the primary backhaul connection is restored and cellular network communications resume using only the primary backhaul connection to communicate with the primary cellular network core.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known, processes, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A system for providing redundant backhaul for a cellular network, the system comprising:
a cellular network access point, wherein user equipment communicate with the cellular network access point wirelessly using a cellular radio access technology;
a primary cellular network core, wherein the cellular network access point uses the primary cellular network core for providing core cellular network functionality;
a primary backhaul connection for communication between the cellular network access point and the primary cellular network core;
a secondary cellular network core comprising at least one component redundant to and configured differently than a counterpart component of the primary cellular network core, wherein the secondary cellular network core is in communication with the primary cellular network core; and
a satellite backhaul connection that provides a communication path between the cellular network access point and the secondary cellular network core, wherein
the satellite backhaul connection is used for cellular network communications with the UE performed via the cellular network access point in response to the primary backhaul connection being unavailable.

2. The system for providing redundant backhaul for the cellular network of claim 1, wherein the at least one component redundant to and configured differently than a counterpart component of the primary cellular network core is configured differently to account for greater latency of the satellite backhaul connection compared with the primary backhaul connection.

3. The system for providing redundant backhaul for the cellular network of claim 2, wherein:
the at least one component comprises an access and mobility management function (AMF); and
one or more timers of the AMF of the secondary cellular network core are configured based on latency of the satellite backhaul connection.

4. The system for providing redundant backhaul for the cellular network of claim 3, wherein:
the at least one component comprises a user plane function (UPF); and
the UPF is configured to deliver a quality of service (QOS) based on bandwidth availability of the satellite backhaul connection.

5. The system for providing redundant backhaul for the cellular network of claim 1, wherein the core cellular network functionality comprises authentication of user equipment authorized to communicate using the cellular network.

6. The system for providing redundant backhaul for the cellular network of claim 1, further comprising an edge switch, connected with the cellular network access point, that routes data from the cellular network access point to the satellite backhaul connection when the primary backhaul connection is determined to be unavailable.

7. The system for providing redundant backhaul for the cellular network of claim 1, wherein the secondary cellular network core comprises only a subset of components that are redundant to a set of components of the primary cellular network core.

8. The system for providing redundant backhaul for the cellular network of claim 1, wherein the primary cellular network core and the secondary cellular network core are implemented on a public cloud computing platform.

9. The system for providing redundant backhaul for the cellular network of claim 8, wherein when the satellite backhaul connection is used for cellular network communications in response to the primary backhaul connection being unavailable, an amount of processing resources reserved on the public cloud computing platform for the at least one component is increased.

10. The system for providing redundant backhaul for the cellular network of claim 1, further comprising a second cellular network access point wherein the second cellular network access point accesses the satellite backhaul connection via an integrated access and backhaul (IAB) connection with the cellular network access point.

11. A system for providing redundant backhaul for a cellular network, the system comprising:
a primary cellular network core, wherein one or more cellular network access points use the primary cellular network core for providing core cellular network functionality;
a secondary cellular network core comprising at least one component redundant to and configured differently than a counterpart component of the primary cellular network core, wherein the secondary cellular network core is in communication with the primary cellular network core; and
a satellite backhaul connection that provides a communication path between a cellular network access point and the secondary cellular network core, wherein
the satellite backhaul connection is used for cellular network communications with the cellular network access point in response to a primary backhaul connection being unavailable.

12. The system for providing redundant backhaul for the cellular network of claim 11, wherein the at least one component redundant to and configured differently than a counterpart component of the primary cellular network core is configured differently to account for greater latency of the satellite backhaul connection compared with the primary backhaul connection.

13. The system for providing redundant backhaul for the cellular network of claim 12, wherein:
the at least one component comprises an access and mobility management function (AMF); and
one or more timers of the AMF of the secondary cellular network core are configured based on latency of the satellite backhaul connection.

14. The system for providing redundant backhaul for the cellular network of claim 13, wherein:
the at least one component comprises a user plane function (UPF); and
the UPF is configured to deliver a quality of service (QOS) based on bandwidth availability of the satellite backhaul connection, a latency of the satellite backhaul connection, or both.

15. The system for providing redundant backhaul for the cellular network of claim 11, wherein the primary cellular network core and the secondary cellular network core are implemented on a public cloud computing platform.

16. The system for providing redundant backhaul for the cellular network of claim 15, wherein when the satellite backhaul connection is used for cellular network communications in response to the primary backhaul connection being unavailable, an amount of processing resources reserved on the public cloud computing platform for the at least one component is increased.

17. A method for providing redundant backhaul for a cellular network, the method comprising:
creating a secondary cellular network core in communication with a primary cellular network core;
configuring the secondary cellular network core such that at least one component of the secondary cellular network core is configured differently than a counterpart component of the primary cellular network core;
providing cellular network services to a plurality of user equipment using a primary backhaul connection and the primary cellular network core;
determining that the primary backhaul connection is not available for accessing the primary cellular network core; and
in response to determining that the primary backhaul connection is not available for accessing the primary cellular network core, providing cellular network services using a satellite backhaul connection and the secondary cellular network core.

18. The method for providing redundant backhaul for the cellular network of claim 17, wherein the at least one component configured differently than a counterpart component of the primary cellular network core is configured differently to account for greater latency of the satellite backhaul connection compared with the primary backhaul connection.

19. The method for providing redundant backhaul for the cellular network of claim 17, wherein the primary cellular network core and the secondary cellular network core are implemented on a public cloud computing platform.

20. The method for providing redundant backhaul for the cellular network of claim 19, further comprising increasing an amount of processing resources reserved on the public cloud computing platform for the at least one component when the satellite backhaul connection is used for cellular network communications.
